(19) United States
(12) Patent Application Publication
(10) Pub. No.: US 2026/0062980 A1
(43) Pub. Date: Mar. 5, 2026

(54) DOOR MONITORING SYSTEM AND METHOD

(71) Applicant: Transportation IP Holdings, LLC, Norwalk, CT (US)

(72) Inventors: Afsar Ali, Skokie, IL (US); Ankit Mathur, Bangalore (IN); Ikechi Olakunle Emelogu, Gurnee, IL (US); Jinshiya Jafar, Kerala (IN); Kalisetti Yogendra Prasad, Andhra Pradesh (IN); Karl J. Kobel, Wildwood, IL (US); Lily Finley, Norwalk, CT (US); Matthew Damian Pietrzykowski, Rochester, NY (US)

(73) Assignee: Transportation IP Holdings, LLC, Norwalk, CT (US)

(21) Appl. No.: 19/377,687

(22) Filed: Nov. 3, 2025

Related U.S. Application Data
(63) Continuation-in-part of application No. 18/150,347, filed on Jan. 5, 2023, now Pat. No. 12,485,914.

(30) Foreign Application Priority Data
Mar. 4, 2022 (IN) 202211011920

(51) Int. Cl. E05F 15/73; G06V 10/25; G06V 10/26; G06V 10/764; G06V 10/774; G06V 10/98; G06V 20/52

(52) U.S. Cl. CPC E05F 15/73; G06V 10/25; G06V 10/26; G06V 10/764; G06V 10/774; G06V 10/98; G06V 20/52; E05F 2015/765; E05F 2015/767; E05Y 2900/132; E05Y 2900/531

(57) ABSTRACT

A door monitoring system may include an image sensor that generates signals indicative of a field of view of the image sensors. The field of view may include an environment with a doorway region including at least a portion of a floor in proximity to a door of a vehicle. The system may also include a control circuit that obtains image data indicative of an image of the environment and identifies one or more background regions in the image. The control circuit further identifies a zone of interest, including at least a portion of the doorway region, in the image, and determines an amount of overlap of the one or more background regions with the zone of interest. The control circuit then determines the presence of an anomaly in the image based on the amount of overlap of the one or more background regions with the zone of interest.

### CROSS-REFERENCE TO RELATED APPLICATIONS

This application is a continuation-in-part of U.S. patent application Ser. No. 18/150,347, filed on Jan. 5, 2023, which claims priority to Indian Patent Application number 202211011920, filed on Mar. 4, 2022. The entire disclosures of these applications are incorporated herein by reference.

### BACKGROUND

### Technical Field

The subject matter described herein relates to systems and methods for controlling operation of vehicle doors.

### State of Art

Many modern passenger vehicles and buildings have automated sliding or hinged doors for passengers to load and unload from the vehicle.

Automated doors may be operated by user initiated remote control, by a proximal user entry device (such as a keypad or card reader), or by a system that senses the presence or absence of a person or object (e.g., something other than a person) moving toward the door. Doors moving between an open and closed position have a path that must remain obstruction free for the door to function properly and to prevent damage to the door, the door frame, or any object or person in the path of the doors.

In an attempt to reduce likelihood of damage from contact between a moving vehicle door and an object, the United States federal government mandated Federal Motor Vehicle Safety Standard 118. (Other jurisdictions may have similar standards.) This standard calls for implementation of so-called anti-pinch devices that sense contact when an object is between a closing vehicle door and the associated vehicle door frame. Some anti-pinch devices are contact devices that require physical contact with an object and the vehicle door and/or door frame, whereas other anti-pinch devices are contactless, and do not require such contact.

Contact type anti-pinch devices try to mitigate damage after initial contact between an object and the vehicle door and/or door frame occurs. As soon as contact is detected, a control signal is generated causing the motor moving the door to halt or to reverse direction. Some contact sensors dispose a tube or trim within the relevant vehicle door frame region, and then sense at least one contact-caused parameter such as pressure, capacitance change, optical change, electrical current increase in the door drive motor, etc. The tube or trim may contain spaced-apart electrical wires that make contact only if an object depresses the tube or trim. In practice, such sensors are sometimes difficult to install, and can exhibit varying contact responses, especially as ambient temperature changes. But even if the best contact type anti-pinch device can only begin to function after some physical contact with an object has first occurred. Thus, a corrective command signal is not issued until initial contact occurs. In some instances, corrective action may come too late. For example, upon detecting contact there may be insufficient time to fully halt the closing action of a sliding door on a vehicle parked on a steep downhill incline. An object, which may be a person's hand, could be severely damaged before the closing inertia of the sliding door can be halted.

What is needed in the art is an improved system and method for detecting obstructions in the path of automatic doors and preventing contact between the door and the obstruction.

### SUMMARY

In a first embodiment, the present disclosure describes a system including one or more image sensors configured to generate sensor signals indicative of a field of view of the image sensors, the field of view including an environment with a doorway region, the doorway region including at least a portion of a floor in proximity to a door of a vehicle; and a control circuit configured to: obtain, via the one or more image sensors, image data indicative of an image of the environment; identify, via a trained machine learning model, one or more background regions in the image; identify a zone of interest in the image, the zone of interest including at least a portion of the doorway region; determine an amount of overlap of the one or more background regions with the zone of interest; and determine the presence of an anomaly in the image based on the amount of overlap of the one or more background regions with the zone of interest.

In aspects of the current embodiment, the control circuit is further configured to control operation of the door based on the determination of the presence of the anomaly.

In another aspects of the current embodiment, which may be combined with one or more previously recited aspects of the first embodiment, to control operation of the door, the control circuit is configured to control one or more of (i) opening the door, (ii) closing the door, (iii) maintaining a current physical state of the door, (iv) a manual operation mode, or (v) an automatic operation mode.

In another aspect of the current embodiment, which may be combined with one or more previously recited aspects of the first embodiment, wherein to identify the one or more background regions, the control circuit is further configured to segment, using a trained machine learning model, the image into a plurality of image segments and identify the one or more background regions from the image segments.

In another aspect of the current embodiment, which may be combined with one or more previously recited aspects of the first embodiment, the control circuit is further configured to: generate a background mask from the one or more background regions, the background mask being a binary mask; and wherein to determine an amount of overlap of the background regions with the zone of interest the control circuit is configured to determine an amount of overlap of the background mask with the zone of interest.

In another aspect of the current embodiment, which may be combined with one or more previously recited aspects of the first embodiment, the control circuit is further configured to: compare the amount of overlap of the background regions and the zone of interest to an overlap threshold; and wherein to determine the presence of the anomaly, the control circuit is configured to (i) identify that an anomaly is present if the amount of overlap is less than the overlap threshold or (ii) identify that an anomaly is not present if the amount of overlap is greater than the overlap threshold.

In additional aspect of the current embodiment, which may be combined with one or more previously recited aspects of the first embodiment, the overlap threshold is a dynamic threshold that depends on environmental conditions, operational parameters, and historical performance data.

In another aspect of the current embodiment, which may be combined with one or more previously recited aspects of the first embodiment, in response to identifying the presence of an anomaly, the control circuit is further configured to: identify one or more properties of the anomaly including one or more of a size, location, orientation, persistence, shade, color, opacity, reflectivity, motion characteristics, temporal stability, pixel density distribution, heat signature, behavioral patterns and categorize the anomaly based on the one or more properties.

In another aspect of the current embodiment, which may be combined with one or more previously recited aspects of the first embodiment, the zone of interest comprises a plurality of sub-zones and wherein to determine the presence of an anomaly, the control circuit is configured to: determine an amount of overlap of the background regions with each sub-zone; and determine a presence of an anomaly in the image based on the amount of overlap of the background regions with each sub-zone of interest.

In another aspect of the current embodiment, which may be combined with one or more previously recited aspects of the first embodiment, the control circuit is further configured to generate a notification indicative of the determination of the presence of the anomaly.

In a second embodiment, the present disclosure provides a method that includes: obtaining, via one or more image sensors, image data of a field of view of the one or more image sensors, the field of view including an environment with a doorway region, the doorway region including at least a portion of a floor in proximity to a door; identifying, via one or more control circuits and by a trained machine learning model, one or more background regions of the image; identifying a zone of interest in the image, the zone of interest including at least a portion of the doorway region; determining an amount of overlap of the one or more background regions with the zone of interest; and determining the presence of an anomaly in the image based on the amount of overlap of the one or more background regions with the zone of interest.

In aspects of the current embodiment the method further comprises controlling an operational state of the door based on the determination of the presence of the anomaly.

In another aspect of the current embodiment, which may be combined with one or more previously recited aspects of the current embodiment, controlling the operational state of the door includes controlling one or more of (i) a manual operation mode, (ii) an automatic operation made, (iii) opening the door, (iv) closing the door, or (v) maintaining a current physical state of the door.

In another aspect of the current embodiment, which may be combined with one or more previously recited aspects of the current embodiment, identifying one or more background regions comprises performing, via a trained machine learning model, image segmentation and segmenting the image into one or more background regions.

In another aspect of the current embodiment, which may be combined with one or more previously recited aspects of the current embodiment, the method further comprises generating a background mask from the one or more background regions, the background mask being a binary mask, and wherein determining an amount of overlap of the background regions with the zone of interest comprises determining an amount of overlap of the background mask with the zone of interest.

In another aspect of the current embodiment, which may be combined with one or more previously recited aspects of the current embodiment, in response to identifying the presence of an anomaly, the method further comprises identifying, by the one or more processors and from the image, one or more properties of the anomaly including one or more of a size, location, orientation, persistence, shade, color, opacity, reflectivity, motion characteristics, temporal stability, pixel density distribution, heat signature, behavioral patterns and categorize the anomaly based on the one or more properties.

In another aspect of the current embodiment, which may be combined with one or more previously recited aspects of the current embodiment, the method further comprises: obtaining training image data indicative of training images of the environment, with at least one of the training images including an anomaly in the environment; annotating background regions and anomalies in the plurality of training images to generate annotated training images; training, using the plurality of annotated training images, the machine learning model to identify background regions and perform image segmentation of background regions in images.

In another aspect of the current embodiment, which may be combined with one or more previously recited aspects of the current embodiment, the method further comprises generating a background mask from the annotated background regions, and wherein training the machine learning comprises training the machine learning model to identify background regions and perform image segmentation of background regions based on the background mask.

In another aspect of the current embodiment, which may be combined with one or more previously recited aspects of the current embodiment, the method further comprises performing image augmentations on one or more of the training images to produce additional training images; and training the machine learning model to identify background regions and perform image segmentation of background regions using the additional training images.

In another aspect of the current embodiment, which may be combined with one or more previously recited aspects of the current embodiment, the training images includes one or more images obtained by the one or more image sensors.

### BRIEF DESCRIPTION OF THE DRAWINGS

The subject matter may be understood from reading the following description of non-limiting embodiments, with reference to the attached drawings, wherein below:

FIG. 1 illustrates one example of a door monitoring system and a hinged door that is monitored by the system;

FIG. 2 illustrates another example of the door monitoring system and the hinged door shown in FIG. 1;

FIG. 3 illustrates one example of the door monitoring system and a sliding door that is monitored by the system;

FIG. 4 illustrates another example of the door monitoring system and the sliding door shown in FIG. 3;

FIG. 5A illustrates a flowchart of one example of a method for controlling operation of a door based on a monitored area near the door;

FIG. 5B illustrates a flowchart of a second example of a method for controlling operation of a door based on a monitored area near the door;

FIG. 6A provides an example image captured by an imaging sensor of an environment including a doorway region with a door in a closed state;

FIG. 6B provides an image captured by an imaging sensor of an environment including a doorway region with a door in an open state;

FIG. 7A provides an image of an example environment of a doorway region for performing anomaly detection;

FIG. 7B provides an image of an anomaly being present in a doorway region for performing anomaly detection;

FIG. 8A provides an image of an anomaly present in a doorway region to illustrate background centric anomaly detection;

FIG. 8B provide an example image of annotated objects and background regions in an environment;

FIG. 8C provides an example image of a binary mask indicative of annotated background regions and non-background regions;

FIG. 8D provides an example image of the environment of FIG. 8A with a zone of interest for performing anomaly detection;

FIG. 9 illustrates a flowchart of one example of a method for training a machine learning model to perform one or more processes or operations in determining the presence of an anomaly in an image using background centric anomaly detection.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims.

In addition, prior to explaining various embodiments of the present disclosure in detail, it should be noted that the illustrative examples are not limited in application or use to the details of disclosed in the accompanying drawings and description. It shall be appreciated that the illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof.

The subject matter described herein relates to monitoring systems and methods that detect and optionally count for passengers, persons, and other objects in a door portal of a vehicle, building, or the like. While one or more embodiments are described herein in connection with passengers boarding and leaving a vehicle through the door portal, not all embodiments are limited to vehicles and passengers. One or more embodiments may be used in connection with doors of buildings. References to passengers is not intended to limit all embodiments to vehicles. Unless explicitly disclaimed or stated otherwise, a passenger may include a person entering or exiting a building through a door portal.

The system can include sensors having monitoring ranges or areas that include the entire doorway area (instead of just a portion of the area directly in front of/behind, or adjacent to the door), as well as a trailing edge area and exterior of the door (e.g., outside of the vehicle or building). The system can examine the sensor output to distinguish between passengers standing close to the door, passengers approaching the door, and passengers that are in the doorway portal (while the doors are open or closed). Additionally, the described methods and system may examine the sensor output to identify objects and anomalies that may obstruct the doorway movement in the doorway portal. Based on the sensor output, the system can implement one or more responsive actions, such as controlling opening or closing of the door, maintaining a current physical state of the door, slowing movement of the door (e.g., slow the opening movement of the door and/or slow the closing movement of the door), changing the direction of movement of the door (e.g., reverse the current opening movement of the door to closing movement or reverse the current closing movement of the door to opening movement of the door), setting the door to a manual operation mode (e.g., a user or passenger must control opening and closing of the door), or control an automatic operation of the door (e.g., reducing passenger interaction with the door). The movement of the door can be controlled based on a measured, estimated, or sensed distance between the passenger or object and the door. For example, the speed at which the door closes can be slowed by greater amounts for passengers and objects that are closer to the door than for passengers and objects that are farther from the door. As another example, the speed at which the door opens can be increased for closer passengers than for farther passengers.

The sensor(s) can be optical sensors that output data such as images or video that are used to detect the presence (or absence) of persons or objects. The sensor(s) may or may not include any contact sensors that require physical touch to detect a person or object, and may not include sensors that do not output images or video. For example, the sensor(s) may or may not include infrared, LiDAR, sonar, or other types of sensors that may detect persons or objects based on time of flight, interruption of a light path, etc. The sensor(s) may include cameras or the like. The sensors may include any sensors that are capable of outputting spatial data sets on which a background region may be determined, and further anomalies or objects may be identified based on the steps and operations of the methods described herein.

The monitoring system optionally can count the number of passengers and/or objects passing through the door portal. This information can be used by the monitoring system or another system to determine how many passengers and/or objects are onboard the vehicle or inside the building, and/or how many passengers and/or objects have left the vehicle and/or building. This information can be used for a variety of purposes, including tracking passenger traffic in vehicles such as transit vehicles, counting the number of persons in a building in the event that a headcount is needed (e.g., to determine whether any persons are missing following a disaster or other emergency event, such as a tornado), or the like.

The monitoring system can include optical sensors, such as cameras, that can provide output used for security purposes. The output from the optical sensors can be stored responsive to a trigger event being detected, but otherwise discarded. For example, responsive to detecting the door contacting a person or object while closing, the monitoring system can save the optical sensor output from prior to this event to shortly after the event. As another example, the output from the optical sensor may be stored responsive to a fare collection device determining that a passenger has paid a fare (or passed through a gate of the fare collection device) without paying the fare. In another example, the output from the optical sensor can be stored responsive to a ramp or bridge plate of the vehicle being extended or retracted. The stored output from before the event, during the event, and/or after the event can be used for security, for liability investigations in case of an accident, or the like.

The monitoring system can include the sensors located above the door portal, and optionally mounted to other door components. The sensors can sense possible impedances to door movement. These impedances may include passengers, items carried by passengers, items propelled by passengers (e.g., carts, bikes, strollers, etc.), or items left in the path of the door travel. The monitoring system may detect the presence of these items in a vehicle doorway so that operation of the door may be modulated by the presence or absence of those items. For example, if a passenger is present such that a closing door will contact the passenger, that closing may be prevented or reversed to avoid that contact. The monitoring system may detect and respond without imparting contact on an obstruction.

The detection volume of the sensors can be based on the door size and geometry. This volume may include some of the area on one or both sides of the door (e.g., the passenger standing areas). As one example, the detection volume may range from up to twenty-one inches inside the door opening plane to twenty-one inches outside the door opening plane. Alternatively, the detection volume may be larger or smaller than these dimensions. The sensor of the monitoring system may be able to detect a target in the detection volume (which may be up to fifty-six inches by ninety-seven inches by thirty inches as one example, but alternatively may be a larger or smaller volume).

Throughout this specification, any objects which may be in a doorway or proximate to a doorway that may impede movement of a door may be referred to as anomalies. The described anomalies are intended to include individuals, passengers, limbs (e.g., arms, legs, etc.) backpacks, suitcases personal items, strollers, or any other object which may be present in a region near a doorway. Additionally, the anomalies may reside on a floor near or in the doorway, or may be above the floor in air space of the doorway (e.g., any region or area that the door traverses to open or close).

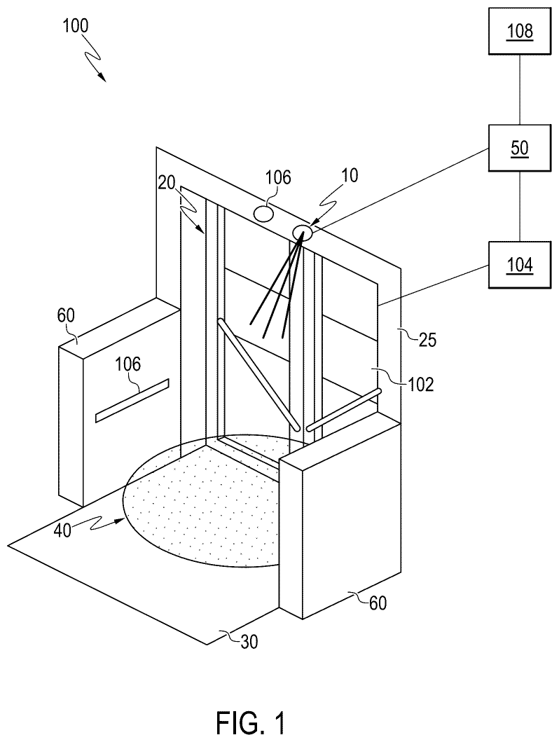

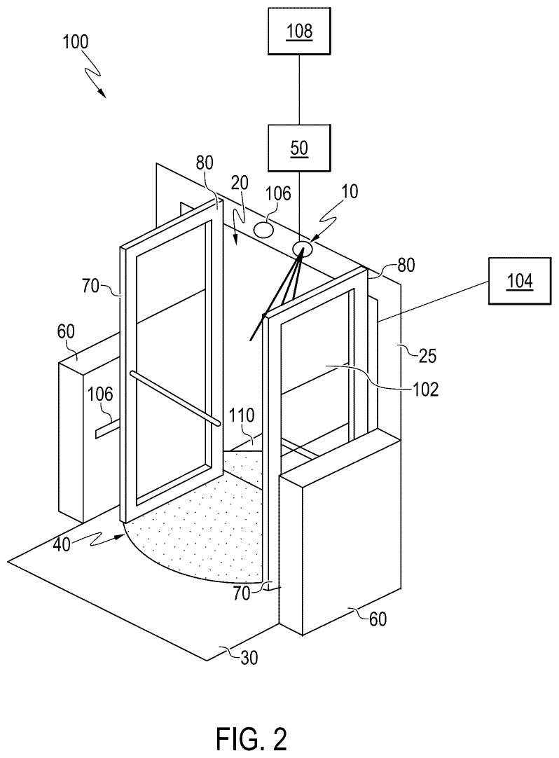

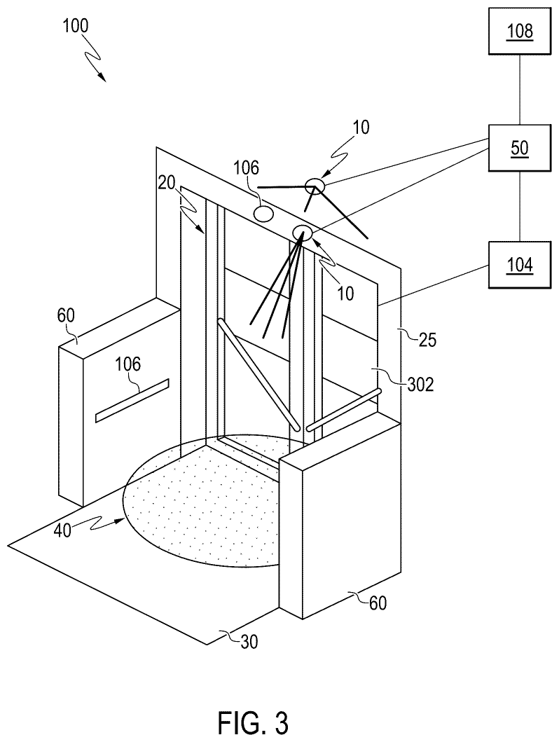

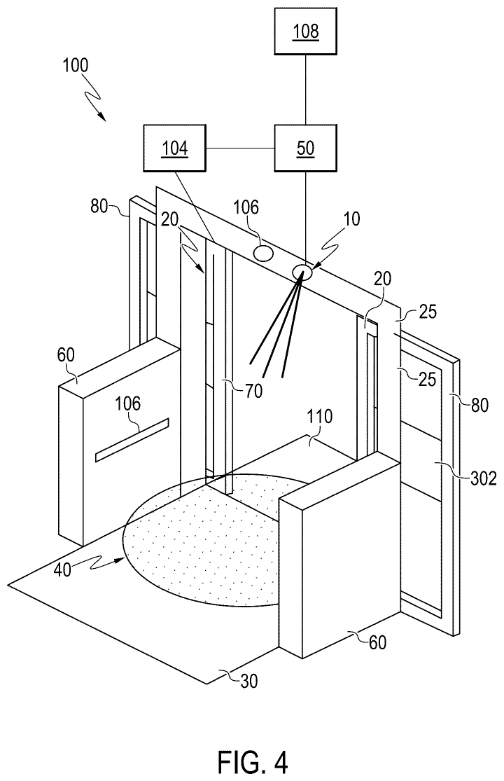

FIGS. 1 and 2 illustrate one example of a door monitoring system 100 and a hinged door 102 that is monitored by the system. FIGS. 3 and 4 illustrate another example of the system used in connection with a sliding door 302. The doors may open or close to permit or prevent passage of persons and/or objects through a door portal 20. The doors may automatically open and close (e.g., under control of one or more actuators 104, such as one or more motors), or the doors may be set to be manually opened via one or more actions of a passenger or operator (e.g., activation of a touch sensor or button). The doors are disposed in a door frame 25 and may include a pair of hinged doors (FIGS. 1 and 2) or sliding doors (FIGS. 3 and 4). FIGS. 1 and 3 show the doors in a closed state or position, while FIGS. 2 and 3 show the doors in an open state or position. Optionally, there may be a single door instead of multiple doors, the door or doors may be accordion doors (having multiple panes with hinges between the panes), or the like. The doors depicted in the Figures are provided merely as one example, and are not limiting on all embodiments of the inventive subject matter described herein.

Each door can include a leading edge 70 and a trailing edge 80, and the system can identify and track movement of the leading edge and/or and trailing edge of the doors during opening and/or closing the doors. The system can stop movement of the door responsive to determining that the leading edge or the trailing edge of the vehicle door will contact the one or more persons or objects if the door continues to move. For example, the system can include at least one sensor 10 that senses passengers, objects, anomalies, and the like, within a monitoring area or range 40 of the sensor. Optionally, the sensor may monitor another part of the door. For example, the sensor may monitor movement of a panel of the door, a marker on the door (e.g., a piece of reflective tape, a painted or printed marker, etc.), or the like, to track movement of the door and prevent the door from striking a person or object.

The sensor can be a camera, as one example. The sensor may be disposed at the top of the door frame or otherwise above the door. Alternatively, the sensor may be disposed elsewhere, such as to one side of the door or in another location. The monitoring area or range may extend down to a floor 30 of the space inside of and/or outside of the doors, and may include air space between the sensor and the floor. The system can include multiple ones of the sensor (or multiple different sensors) that can be redundantly employed such that one sensor can begin working upon the failure of one or more other sensors.

In one embodiment, the monitoring area can be defined by the size of the door and/or the geometry (e.g., shape) of the door. There can be multiple sensors, with each sensor disposed on a different side of the door frame. Each of these sensors can have a monitoring area on a different side of the door and door frame. Alternatively, a sensor may be oriented such that the monitoring area of the sensor can extend through the door portal and encompass both sides of the door when opened. The sensor or sensors may be disposed in any different position or positions that have field(s) of view of the door(s), around the door(s), outside of the door(s), inside the door(s), or the like. For example, the sensor(s) may be disposed above a door, across a door (e.g., on the opposite side of a door in the vehicle), on a side of the door, below a door, outside of a door, etc.

The monitoring area can extend from up to twenty-one inches inside the door opening plane to twenty-one inches outside the door opening plane. Alternatively, the monitoring area may be larger or smaller. The sensor(s) can be oriented and positioned to detect obstructions, persons, and/or other objects in a large space, such as a space up to fifty-six inches (extending in a direction away from the door portal), by ninety-seven inches (up from the floor), by thirty inches wide (extending in a lateral direction), or another size.

The described system and sensor may detect or sense possible impedance or anomalies in images that could impede door movement. These may include passengers, body parts of passengers, items carried by passengers, items propelled by passengers (carts, bikes, or strollers, etc.), or items left in the path of the door travel. The sensor and system can detect the presence of these items and anomalies in the doorway or door portal so that operation (e.g., movement) of the door may be controlled based on the presence or absence of those items and anomalies. For example, the system can include a control circuit 50 that controls operation of one or more actuators or motors that move the door between open and closed states. The control circuit can represent hardware circuitry that includes and/or is connected with one or more processors (e.g., integrated circuits, field programmable gate arrays, integrated circuits, etc.) that operate as described herein in connection with the control circuit. The control circuit can receive outputs from the sensor to determine whether to open or close, or stop opening or closing, of the door. For example, the output from the sensors indicates, that a passenger or object is present such that a closing door will contact the passenger or object, the control circuit can direct the actuators(s) to stop closing of the door and/or to reverse movement of the door.

The sensor and/or control circuit can differentiate between persistent objects 60 and intermittent objects or persons by identifying a background region in an image, and further identifying anomalies as any objects or regions in images that are not part of the background. A persistent or background object can be an object that remains present or stationary, and may be within the monitored area of the sensor and system. An intermittent object or an anomaly can be an object or person that does not remain present or stationary, and instead moves relative to the door such that the intermittent object is not always present within the monitored area or field of view of the sensor(s). Examples of persistent objects include handrails, modesty guards, support elements, or the like, which would each be identified as objects that are part of the background of the image. The controller can be programmed or learn (e.g., using artificial intelligence or machine learning) differences between persistent and background objects verses intermittent objects and anomalies. The controller can categorize different types of objects detected by the sensor(s) to learn different types of obstructions based on the environment of the system and the event to which the system is exposed. For example, over time, the controller can learn (or be programmed) to distinguish between irrelevant intermittent objects or obstructions such as papers, leaves, precipitation outside of the door, etc., and a relevant obstructions or anomaly such as a person, stroller, or the like. Therefore, a trained machine learning model may classify such irrelevant intermittent objects as background due to the fact that the objects generally do not impede movement of a door. The controller may not change or stop movement of the door responsive to detecting an irrelevant obstruction or intermittent object, but may stop or change the direction of movement of the door responsive to detecting a relevant obstruction and identified anomaly.

The controller optionally can be programmed or learn to identify a passenger gesture to change a state or direction of movement of the door. For example, the sensor can detect, and the controller can interpret detection (by the sensor) of a waving hand, a raised hand, or other predefined or designated movement by a person as an indication to change movement of the door. This change in movement can be opening the door, closing the door, stopping current movement of the door, or slowing current movement of the door. The controller can direct the actuator(s) to change the movement of the door or authorize movement of the door, as indicated by the gesture. This can reduce the instances in which passengers are required to touch surfaces in or around the door. While the movement of the door is performed by actuators, the command to open the door, in the current example, is provided by a user and therefore considered a manual operation or command to open the door.

The controller can change the monitored area by modifying one or more characteristics of the sensors, such as a focal length, orientation, etc. Optionally, the controller can receive data output from the sensor(s) for the larger monitored area but examine a smaller portion or fraction of the monitored area. As one example, the controller can examine a smaller portion of the monitored area that includes or is in front of a designated area. This designated area can include a button, sign, or the like, where movement of a person, the presence of a hand of the person, or the like, is detected by the controller. Responsive to detecting the person in the smaller portion of the monitored area, the controller can control the actuators to open the door.

For example, the controller can examine the sensor data representative of movement or the presence of a person/object within a small, narrow rectangle zone located along the inside of the doors. Detection of a person in this zone may indicate a request to open the door. If the controller determines that the door is already closed (e.g., by monitoring the sensor output) and that the door is authorized to be opened (e.g., based on whether the vehicle is moving and/or operator input), then the controller can automatically control the actuator(s) to open the door.

The controller can examine the sensor output and determine whether to prevent or authorize movement of the door. The preceding example relates to controlling a movement of the door based on a gesture, the controller optionally can permit or prevent the door from being opened (by controlling the actuator(s) and/or lock(s)) based on detection of a person or object within the monitored area or range of the sensor(s). If the controller determines that a person is within the monitored area, the controller may control the actuator(s) to allow the door to be opened. For example, the controller may direct the motors to no longer prevent the door from being opened to allow a person to manually open the door. If no person is detected within the monitored area, the controller may control the actuator(s) to prevent the door from being opened.

In one embodiment, the controller may direct the actuator to open, close, permit opening, or prevent opening of the door responsive to a person or anomaly being detected by the sensor(s), the date, and/or the time of day. The controller may base the decision on whether to open, close, permit opening, or prevent opening of the door based on time due to certain periods of time being associated with increased likelihoods of persons being intoxicated or sleeping near the door. For example, if the controller detects a person near the door (within the monitored area), the day is on a weekend (or another date, such as a holiday, associated with increased consumption of intoxicants), and/or the time is late at night or early in the morning, the controller may prevent the door from opening. This can prevent a person that is intoxicated or sleeping near the door from falling out of the vehicle (while the vehicle is moving or stationary) if the door were to open.

The controller can change or control a speed at which the door moves based on the sensor(s) detecting the presence or absence of a person or anomaly. If the controller determines that a person or anomaly is within the monitored area, the controller may slow down or restrict the speed at which the door moves in a closing direction (to close the door) or speed up or allow faster speeds at which the door moves in an opening direction (to open the door). Conversely, if the controller determines that a person or anomaly is not within the monitored area, the controller may close the door at faster speeds (relative to when a person is detected) or open the door at slower speeds (relative to when a person is detected). This can help reduce the likelihood of a person being struck by the closing door or colliding with a slower moving door that is opening.

The controller optionally can change or control a speed at which the door moves based on the sensor(s) detecting movement of a person. If the controller determines that a person is moving toward the door that is open but closing, the controller may slow down the speed at which the door was moving (e.g., until the person moves through the door portal and is clear of the door). If the controller determines that a person is moving toward the door that is opening (but not fully open), the controller may increase the speed at which the door was moving (e.g., to ensure the door is open when the person reaches the door).

The controller can determine whether an anomaly such as an object is resting, abutting, or otherwise contacting the door based on the sensor output. The controller can then prevent the door from being opened until the object is no longer leaning against or abutting the door. This can prevent the object from falling out of the door if the door were to be opened.

Changes in lighting conditions (e.g., the ambient light) within the monitored area can negatively impact the ability of the sensor(s) to detect objects or persons in the monitored area and/or the ability of the controller to identify the objects or persons in the sensor output. For example, very low or dim light may make the objects, persons, gestures, etc. difficult to detect or identify. The system can include one or more lamps 106 that are controlled by the controller to generate light. The lamps can represent incandescent lights, light emitting diodes, or other devices that generate light. The lamps can be disposed above the door, to the side of the door, on or in the door, on or in the floor, etc. The controller can direct the lamps to activate and generate light responsive to the controller being unable to detect persons or objects in the sensor output and/or the sensor(s) being unable to detect one or more persons or objects within a threshold period of time. For example, if there normally are persons and/or objects within the monitored area but none have been detected for an extended period of time, the controller may determine that there is insufficient light and activate the lamp(s).

Optionally, the lamp(s) can generate light or change the color of the light that is generated to notify passengers of a state of the door. For example, the controller can direct the lamp(s) to generate a green light to indicate that the door is unlocked, permitted to be opened, or is open. The controller can direct the lamp(s) to generate a yellow light to indicate that the door is opening or permitted to be opened (but not yet open). The controller can direct the lamp(s) to generate a red light to indicate that the door is closed, locked, or otherwise not permitted to be opened.

The controller may communicate with an output device 108 to communicate information with an operator of the vehicle, security of a building, or the like. For example, the controller can send a warning or notification via a flashing light, alphanumeric message, audible alarm, or the like, to a driver of the vehicle. The warning or notification can be sent responsive to detecting the presence of a person or object outside of the door. As described above, the monitored area or field of view of the sensor(s) may extend outside of the door (e.g., outside of the vehicle or building). The controller can send a warning to the operator of the vehicle responsive to detecting the presence of a person outside of the door. Optionally, the output device shown in the Figures can represent a vehicle control unit that controls operation of the vehicle. The vehicle control unit can represent hardware circuitry that includes and/or is connected with one or more processors that can control operation of the vehicle. The controller can send a signal to the vehicle control unit to prevent the vehicle from moving responsive to detecting the presence of a person outside of the door. This can prevent the vehicle from moving and potentially striking the person that is nearby, but outside of, the vehicle. Optionally, instead of preventing movement of the vehicle, the control unit can restrict the speed and/or direction in which the vehicle moves responsive to detecting a presence of a person outside the door.

The vehicle may include a deployable passenger device 110 that can be controlled by the same or different actuators that control movement of the door. The deployable passenger device can represent a ramp, bridge plate, stairs, lift, or a platform that can extend from the vehicle in one state and retract back into or toward the vehicle in another state. In the extended state, the passenger device can provide a surface for passengers to walk on while exiting or entering the vehicle through the door. The passenger device may need to retract to avoid colliding with persons or objects while the vehicle is moving. In one embodiment, the controller can direct the actuators to retract the passenger device responsive to the sensor output indicating that a person is outside of the door. This can prevent persons from being struck by the passenger device or trapped between the passenger device and a platform or other surface outside of the vehicle.

Optionally, the controller can examine the sensor data to determine whether there is a person or object on the passenger device. The controller may not move the passenger device if a person or object is detected on the passenger device. For example, if a person or object is detected on a deployed ramp, plate, or stairs, the controller can prevent the actuator(s) from retracting the ramp, plate, or stairs to prevent a person or object from falling off the ramp, plate, or stairs.

The controller can track how many people and/or objects are onboard the vehicle or inside the building via the door based on the sensor output. The controller can monitor the sensor output to count the number of persons entering into the vehicle or building, and/or exiting the vehicle or building via the door portal. This information can be used to determine how many people are onboard the vehicle or in the building over time (or at different times). This information can be used to calculate whether additional vehicles need to be scheduled to travel along certain routes (due to overcrowding on the vehicle), whether any persons remain in a building (e.g., after an emergency event where a head count is needed, etc.). In one example, the controller may only count the number of passengers and/or objects entering and/or exiting the vehicle (or building) while the door is open. This can help prevent mis-counting the number of persons or objects onboard the vehicle or inside the building.

The controller can examine the sensor output to monitor a health state of the door. The health state of the door can indicate whether the door is operating as expected, or whether the door is operating in an unexpected or undesirable manner. For example, the controller can monitor the speed and/or paths of movement of the leading and/or trailing edges of the doors to determine whether the speed and/or paths are within designated acceptable ranges. If a door is moving faster or slower than a designated range of speeds and/or a leading or trailing edge of the door is moving outside of a designated area or volume, then the controller can determine that the door has a health state that may require inspection and/or maintenance. As another example, if the door is moving (e.g., opening or closing) while the door is supposed to be open or closed, then the controller can determine that the door has a health state that may require inspection and/or maintenance. The controller optionally can change how the door is opened responsive to determining that the door is in this state. For example, the controller can control the actuator and/or lock to prevent the door from opening, can send a signal to the vehicle or operator of the vehicle to stop the vehicle, or the like.

Optionally, the controller can monitor the operation, state, and/or health of components, persons, and/or objects in addition to or as alternates to the door. For example, the field of view of the sensor(s) can capture operation of a lift, ramp, or the like, that is used to assist passengers boarding and/or disembarking from the vehicle. The controller can monitor output from the sensor(s) to determine whether the state of the lift, ramp, or other component is acceptable for the vehicle to begin movement. For example, if the sensor output indicates that a ramp or lift is deployed, the controller may notify an operator of the vehicle to refrain from moving the vehicle and/or may automatically stop movement of the vehicle. As another example, if the sensor output indicates that a ramp or lift is deployed and a passenger is on or near (e.g., within a threshold distance) of the ramp or lift, the controller may notify an operator of the vehicle to refrain from moving the vehicle and/or may automatically stop movement of the vehicle. As another example, if the sensor output indicates that a wheelchair has wheel(s) on the deployed ramp or lift, the controller may notify an operator of the vehicle to refrain from moving the vehicle and/or may automatically stop movement of the vehicle.

The sensor may have a field of view that is outside the vehicle to assist the operator of the vehicle in identifying the presence of persons or objects outside the vehicle but in a position or location at risk of being struck by the vehicle. For example, the sensor may have a field of view that encompasses an area or volume of the front right side of the vehicle. During right turns of the vehicle, the operator (e.g., driver) may have reduced visibility in this area or volume. The controller may monitor the sensor output to identify the presence of person(s) and/or object(s) within this area. If a person and/or object is identified in this area or volume, the controller may notify an operator of the vehicle to refrain from moving the vehicle and/or may automatically stop movement of the vehicle.

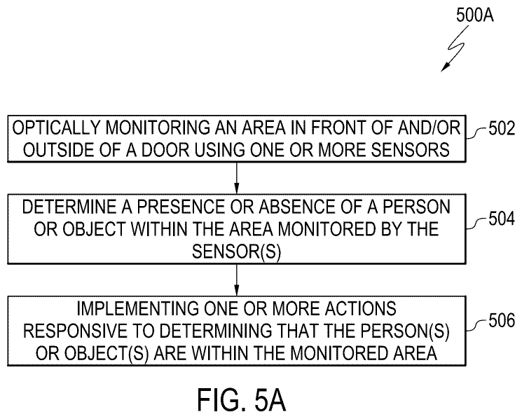

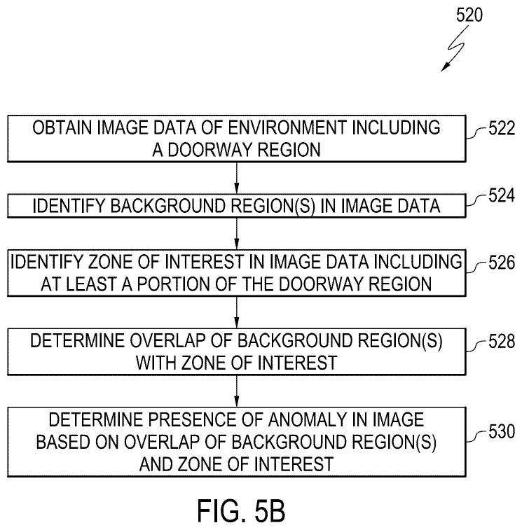

FIG. 5A illustrates a flowchart of one example of a method 500 for controlling operation of a door based on a monitored area near the door. The method can represent operations performed by the monitoring system. At step 502, an area in front of and/or behind a door is optically monitored using one or more sensors. This area can be defined by a field of view of optical sensor(s) that includes at least part of an interior vehicle floor in front of the door. At step 504, a presence or absence of the one or more persons or objects within the field of view of the sensor(s) is determined. This determination may be completed using the data that is output by the sensor(s). At step 506, one or more actions are implemented responsive to detecting the presence or absence of a person or object. As one example, the door may be authorized (e.g., allowed) to open or may be opened when a person or object is detected, and/or when a passenger gesture is detected. As another example, the door may be prevented from opening. In another example, a speed at which the door moves may be changed. The door may be prevented from being opened based on detecting the presence of the one or more persons or objects abutting the door.

FIG. 5B illustrates a flowchart of a second example embodiment of a method 520 for controlling operation of a door based on a monitored area near the door. The method can represent operations performed by the monitoring system. An area in front of and/or behind a door is optically monitored using one or more sensors and the one or more sensors obtain 522 image data indicative of an environment including at least a portion of the doorway region. The doorway region may include one or both of areas in front of and/or behind the door. The doorway region may also include any area that the doors traverse during movement. A trained machine learning model identifies 524 one or more background regions in the image data. The trained machine learning model may be executed by the control circuit, or by another processor. The background regions may include objects associated with the doorway that are normally present such as any permanent structures such as handrails, stairs or steps, seats, etc. The trained machine learning model may further be trained to identify environmental objects and features of the image data that are not obstructions to door movement such as leaves, rainwater, small garage or small detritus, etc. The control circuit may generate a background mask from the identified background regions. The background mask may be a binary image mask indicative of the background regions, or may be another type of image mask for performing the processes and methods described herein. In further implementations, the control circuit may implement a machine learning model to segment the image data into a plurality of image segments. The various image segments may then be identified as background regions, and non-background regions.

A zone of interest is identified 526 in the image data. The zone of interest includes at least a portion of the doorway region (e.g., area of floor or air space in front or and/or behind the door). The control circuit determines 528 an amount of overlap of the one or more background regions with the zone of interest. The amount of overlap of the one or more background regions and the zone of interest may be quantified by a number of pixels of overlap in the image data, or may be determined based on the area of the physical imaged environment, among other implementations. In specific implementations, the control circuit may determine the amount of overlap using the background mask and identifying the overlap of the background mask with the zone of interest. The control circuit determines 530 the presence of an anomaly in the image based on the amount of overlap of the one or more background regions and the zone of interest. The method may further include determining that an anomaly is present in the image if the amount of overlap is less than a determined overlap threshold value, or determining that no anomaly is present if the amount of overlap is greater than the overlap threshold value. For example, if the majority of the zone of interest overlaps with the identified background region(s) then the method may determine that there is no anomaly, or a low likelihood of an anomaly in the image. Otherwise, if there is very little overlap of the zone of interest and the background region(s), there is a high likelihood of the presence of an anomaly. In examples, the described overlap threshold may be a static value, or a dynamic value.

The dynamic overlap threshold value may depend on several operational and environmental factors including one or more of ambient lighting conditions, time of day, weather conditions, door operational state, historical performance data, and anomaly persistence characteristics. Environmental factors such as low light conditions or adverse weather may require a lower threshold to account for reduced background detection accuracy, while optimal lighting conditions may allow for higher threshold values. The threshold may also be dynamic or adapt based on door state, with different values for open versus closed door positions, as the visible background regions may change significantly under different door conditions. Additionally, the dynamic threshold may incorporate persistence analysis, where brief transient anomalies (lasting only a few frames) may trigger higher threshold values to reduce false alarms, while sustained anomalies (persisting across multiple consecutive frames) may warrant lower threshold values for enhanced safety response. The threshold may further be adjusted based on vehicle occupancy levels, emergency operational modes, maintenance activities, and real-time system performance metrics to optimize detection sensitivity while minimizing false alarms across varying operational scenarios.

The control circuit may further identify features of an anomaly. For example, after an anomaly has been identified in the image data, the control circuit may further identify one or more of a size, location, orientation, persistence, shade, color, opacity, reflectivity, motion characteristics, temporal stability, pixel density distribution, heat signature, behavioral patterns and categorize the anomaly based on the one or more properties. The control circuit may then categorize the anomaly based on the identified properties such as identifying the anomaly as a person, a heavy object, an object resting on the floor, etc. Additional properties that may be identified include motion characteristics (velocity, acceleration, direction of movement), temporal stability (consistency of the anomaly's appearance across frames), depth information (distance from camera, three-dimensional positioning if we use 3D Camera in future), pixel density distribution, heat signature (with thermal imaging systems), and behavioral patterns (stationary, oscillating, approaching, or receding movement). The control circuit may also identify contextual properties such as proximity to door edges, height above floor level, interaction with other detected objects, and temporal patterns of appearance and disappearance. These comprehensive visual and behavioral characteristics enable more sophisticated anomaly classification, allowing the system to distinguish between different types of obstructions such as passengers, luggage, wheelchairs, small debris, or maintenance equipment, thereby enabling more nuanced and appropriate door control responses.

The method may further include performing one or more actions responsive to detecting the presence or absence of a person, object, or anomaly. In at least one embodiment, the control circuit may authorize (e.g., allow) the door to open or may open the door when a person or object is detected, and/or when a passenger gesture is detected. As another example, the control circuit may prevent the door from opening. In additional embodiments, the control circuit may control a speed at which the door moves. The control circuit may prevent the door from being opened based on detecting the presence of the one or more anomalies abutting the door. The control circuit may generate a notification indication of the determination of the presence of the anomaly. For example, the control circuit may provide a notification of a presence, or absence, of an anomaly via one or more user interfaces, an audio output, a visual output, etc.

In some implementations, the control circuit may identify sub-zones in the zone of interest. For example, the control circuit may identify various sub-zones with different risk or ratings such as high-risk zones (e.g., closer to a door), and lower risk zones (e.g., further from the door). The control circuit may determine an amount of overlap of background regions with each respective sub-zone of interest to identify the presence of an anomaly across each sub-zone. The control circuit may then control the operation of the door based on the presence of the anomaly in each sub-zone. For example, the control circuit may control the door to prevent opening of the door if the anomaly is identified as being in a high-risk zone (e.g., very close to the door), or the control circuit may allow for slow opening of the door if the anomaly is identified as being in a lower risk sub-zone (e.g., further from the door, but still in or near the doorway). The control circuit may identify or differentiate high-risk and low-risk sub-zones based on a distance or position threshold. For example, the control circuit may identify a sub-zone as high risk if the entire sub-zone, or a portion of the sub-zone, is closer to the door as compared to a given distance threshold (e.g., 0-5 inches from the door, 0-10 inches from the door, 5 to 12 inches from the door, etc.). The control circuit may further identify a low-risk sub-zone as a sub-zone with at least a portion of the sub-zone further from the door than a determined threshold distance. Further, the control circuit may identify a high- or low-risk sub-zone depending on a height of the sub-zone in the image from the floor. As such, the control circuit may utilize distance and position threshold values to identify various risk values (e.g., high-risk, medium risk, low-risk, very low-risk, etc.) for different sub-zones.

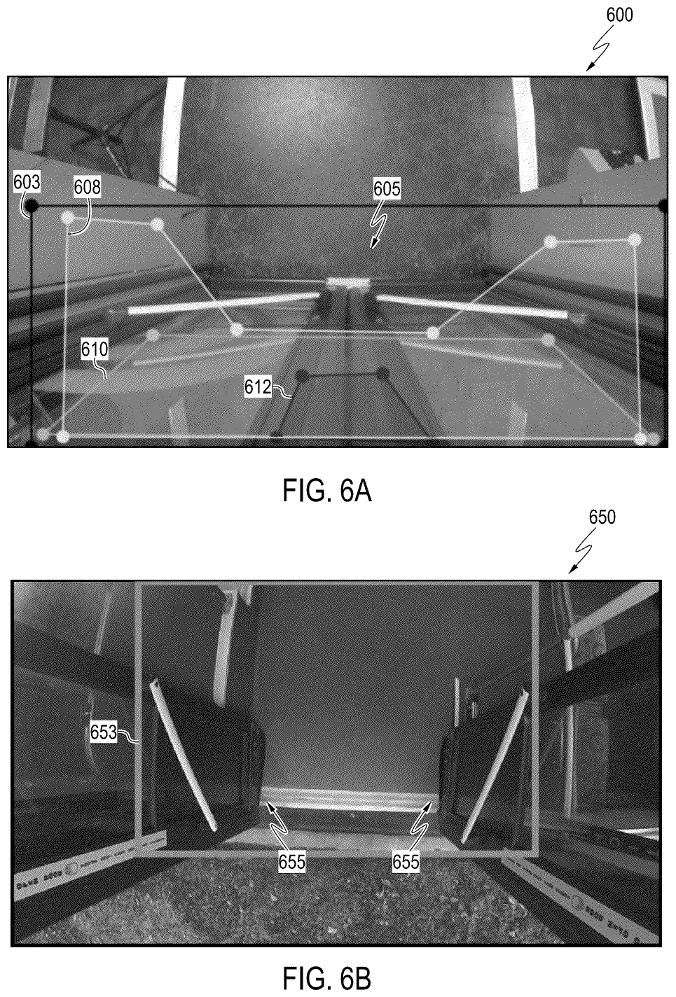

FIG. 6A provides an example image 600 captured by an imaging sensor, the example image being of an environment including a doorway region 603 with a door 655 in a closed state. The doorway region 605 may be determined as a zone of interest for the described methods and systems. The doorway region includes a first sub-zone 608, a second sub-zone 610, and a third sub-zone 612. The first sub-zone includes regions of the environment that the door may traverse during opening and closing of the door. The second sub-zone 610 may include areas of the image that include physical parts of the door, and the third sub-zone may be a region of the door near or at eye level or a person's head or face. A user or the control circuit may determine that the sub-zones to have different risk values or ratings. For example, an anomaly detected in the first sub-zone may include a person standing in the first sub-zone, or may include a bag or item disposed in the first sub-zone. The control circuit may identify that an anomaly is in the first sub-zone, at a position away from the door, and may control movement of the door to open or close slowly as to reduce any impact with the anomaly. In other examples, an anomaly present in the third sub-zone may be detected, which may include a person's face pr head, and the control circuit may cause the door to remain open, or closed, based on the presence of the anomaly in the third sub-zone.

FIG. 6B provides an image 650 captured by an imaging sensor of an environment including a doorway region 653 with a door 655 in an open state. While the doorway is open, the entire doorway region may be considered as the zone of interest to prevent collisions of the door with individuals and objects moving into and out of the doorway region. For example, it is expected that people are boarding and exiting through the doorway region while the door is open. As such, upon detection of any anomaly in the doorway region near the door, the control circuit may stop or prevent motion of the door, or control the door to be in a manual or automated state to prevent collisions with objects or anomalies in the doorway region. The control circuit may increase the area of the zone of interest in an image while a door is in an open state to detect people and anomalies approaching the door and to further prevent collisions with the door.

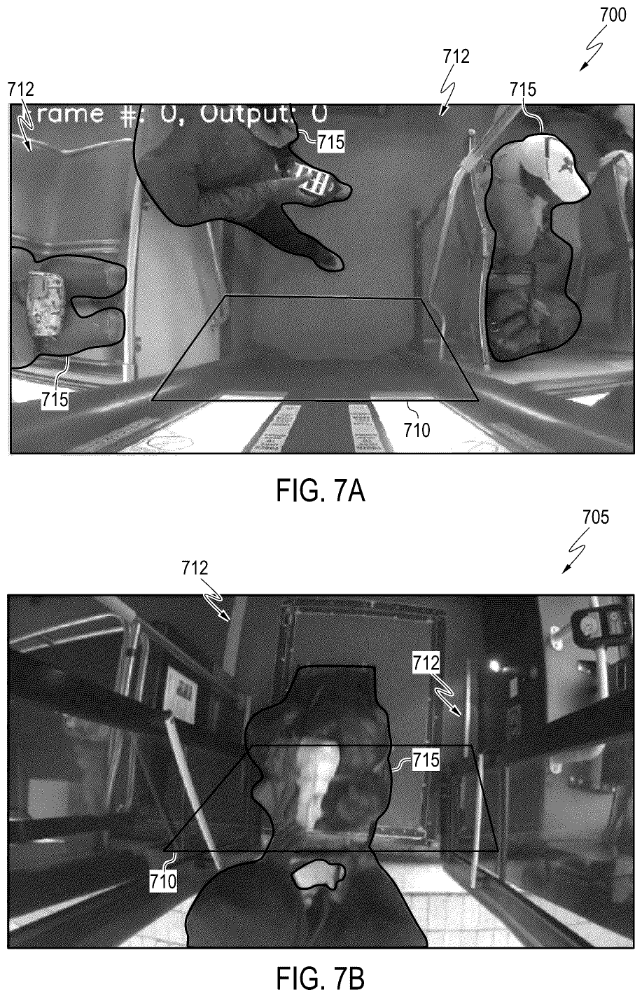

FIGS. 7A and 7B provide images 700, 705 of an example environment of a doorway region 710. FIGS. 7A and 7B show various background regions 712, and non-background regions 715. Three background regions in FIG. 7A are shown to include seats, structural elements such as poles and dividers, and handles. The non-background regions of FIG. 7A include people, bags, hats cell phones, and other objects. None of the non-background regions overlap with the doorway region 710 in FIG. 7A, and therefore, the overlap of the zone of interest (e.g., the doorway region) and the background regions is 100%, or nearly 100%. As such, the control circuit may determine, due to the high amount of overlap of the background regions with the zone of interest, that an anomaly does not exist in the doorway region of FIG. 7A.

FIG. 7B shows an image of an anomaly being present in the doorway region. The doors, in FIG. 7B, are in an open state and a person is moving through the doorway region with a bag. The background region of FIG. 7B further includes the open doors, an extendable boarding ramp, and other structural and functional features of the vehicle. In the example of FIG. 7B, the control circuit may determine a low amount of overlap of the background regions with the zone of interest (e.g., doorway region) and may determine that an anomaly exists in the zone of interest. The control circuit may then provide indications of the existence of the anomaly in the doorway region, or may otherwise control the movement of the door accordingly.

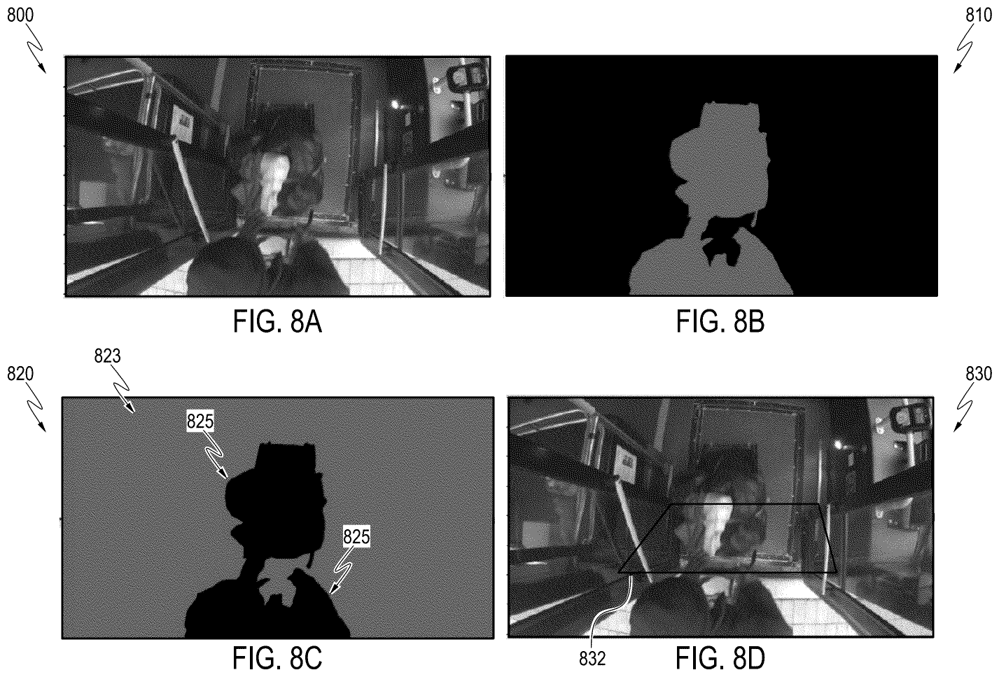

FIGS. 8A-8D provide images of an example implementation of the describe methods for determining the presence of an anomaly in a zone of interest. FIG. 8A provides an image 800 of an environment including a doorway region with a person entering the doorway region with a bag. FIG. 8B provides an image 810 of annotated objects or potential anomalies in the image. FIG. 8C provides an example image 820 of a binary mask indicative of determined background regions 823 and non-background regions 825. FIG. 8D provides an example image 830 with a zone of interest 832. The control circuit may then determine the amount of overlap of the binary mask of FIG. 8C and the zone of interest, and further determine the presence of an anomaly (e.g., the person and bag moving through the zone of interest) based on the amount of overlap.

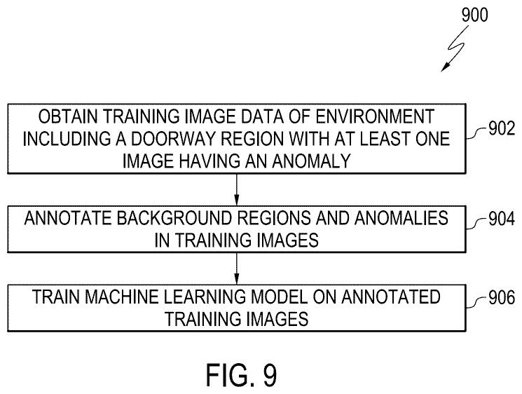

FIG. 9 illustrates a flowchart of one embodiment of a method 900 for training a machine learning model to perform one or more processes and operations in determining the presence of an anomaly in an image as described herein. The method can represent operations performed by the monitoring system with imaging sensors and one or more control circuits. The image sensors obtain 902 training image data, including one or more images, of the environment including the doorway region. At least one of the images includes an anomaly in the image. A user, processor, or control circuit then annotates 904 background regions and anomalies in the images. A user may manually annotate the background regions via a user interface (e.g., mouse, keyboard, touchscreen, etc.). In various embodiments, the control circuit may compare one or more images with anomalies to an image indicated as having no anomalies and the control circuit may further annotate changes in the images as potential anomalies. The control circuit may then use the annotated images to train a machine learning model to further identify background regions in images. The machine learning model may be trained, using the annotated training images, to segment additional images into background regions, and non-background regions, for calculating overlap of background regions with zones of interest and further identifying the presence of anomalies in zones of interest. Training the machine learning model may further include generating a background mask based on the annotated background regions in the training images, and further performing image segmentation on the training images based on the background mask.

Training the machine learning model may include the control circuit, or a dedicated graphics processing unit, generating additional images from obtained images to increase the number of training images. For example, the control circuit may perform one or more image transformations, augmentations, or distortions on images, or portions of images, to generate additional training image data. The control circuit may perform one or more of image skewing, stretching, cropping, scaling, shearing, perspective transforms, or another spatial or geometric transformation. Additionally, the control circuit may brighten or darken images, increase or decrease image resolution, perform blurring, sharpening, add lens flare, add lens distortion, add reflections, etc. to generate additional training images. Training the machine learning model may then be performed using the additional generated training images to allow for more robust operation across a wide range of operating conditions and environments.

In one embodiment, the system may have a local data collection system deployed that may use machine learning to enable derivation-based learning outcomes. The control circuit may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In embodiments, the system may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

In various embodiments, a system (e.g., a monitoring system, such as a vehicle monitoring system or a door monitoring system) includes an optical sensor that may generate sensor signals indicative of a field of view of the optical sensor. The field of view including an environment with a doorway region, the doorway region including at least a portion of a floor in proximity to a door of a vehicle. The system further includes a control circuit that may obtain, via the one or more image sensors, image data indicative of an image of the environment. The control circuit identifies, via a trained machine learning model, one or more background regions in the image and identifies a zone of interest in the image, the zone of interest including at least a portion of the doorway region. The control circuit then determines an amount of overlap of the one or more background regions with the zone of interest, and determines the presence of an anomaly in the image based on the amount of overlap of the one or more background regions with the zone of interest.

The control circuit may control operation of the door based on the determination of the presence of the anomaly. To identify the one or more background regions, the control circuit may segment, using a trained machine learning model, the image into a plurality of image segments and identify the one or more background regions from the image segments.

The control circuit may generate a background mask from the one or more background regions. The background mask may be a binary mask. The control circuit may determine the amount of overlap of the background regions with the zone of interest by determining an amount of overlap of the background mask with the zone of interest.

The control circuit may further compare the amount of overlap of the background regions and the zone of interest to an overlap threshold, and may (i) identify that an anomaly is present if the amount of overlap is less than the overlap threshold or (ii) identify that an anomaly is not present if the amount of overlap is greater than the overlap threshold. The overlap threshold may be a dynamic threshold that depends on environmental conditions, operational parameters, and historical performance data. The environmental factors may include ambient lighting levels, weather conditions, time of day, and seasonal variations that affect background region detection accuracy. The control circuit may further adjust the threshold based on operational parameters such as door state, vehicle or building occupancy levels, emergency modes, and maintenance activities. The original overlap threshold may be established at approximately 95% based on training data analysis and safety requirements, wherein anomaly detection is triggered when background overlap falls below this percentage. The control circuit may dynamically adjust this baseline threshold within a predetermined range based on real-time conditions and historical performance metrics to optimize detection accuracy while minimizing false alarms.

To control operation of the door, the control circuit may control one or more of (i) opening the door, (ii) closing the door, (iii) maintaining a current physical state of the door, (iv) a manual operation mode, or (v) an automatic operation mode.

In response to identifying the presence of an anomaly, the control circuit may identify one or more properties of the anomaly including a size, location, orientation, persistence, shade, color, opacity, reflectivity, motion characteristics, temporal stability, pixel density distribution, heat signature, behavioral patterns and categorize the anomaly based on the one or more properties. The control circuit may categorize the anomaly based on the one or more properties.

The zone of interest may include a plurality of sub-zones and the control circuit may determine an amount of overlap of the background regions with each sub-zone, and determine a presence of an anomaly in the image based on the amount of overlap of the background regions with each sub-zone of interest.

The control circuit may generate a notification indicative of the determination of the presence of the anomaly. Determining an amount of overlap of the background regions with the zone of interest may include determining an amount of overlap of a background mask with the zone of interest.

In another example, a method is provided that may include obtaining, via one or more image sensors, image data of a field of view of the one or more image sensors. The field of view may include an environment with a doorway region, the doorway region including at least a portion of a floor in proximity to a door. The method may include identifying, via one or more control circuits and by a trained machine learning model, one or more background regions of the image. The method may also include identifying a zone of interest in the image, the zone of interest including at least a portion of the doorway region. The method may further include determining an amount of overlap of the one or more background regions with the zone of interest, and determining the presence of an anomaly in the image based on the amount of overlap of the one or more background regions with the zone of interest.

The method may include controlling an operational state of the door based on the determination of the presence of the anomaly. Controlling the operational state of the door may include controlling one or more of (i) a manual operation mode, (ii) an automatic operation made, (iii) opening the door, (iv) closing the door, or (v) maintaining a current physical state of the door.

Identifying one or more background regions may include performing, via a trained machine learning model, image segmentation and segmenting the image into one or more background regions. The method may include generating a background mask from the one or more background regions, the background mask being a binary mask. The method may also include determining an amount of overlap of the background regions with the zone of interest by determining an amount of overlap of the background mask with the zone of interest.

In response to identifying the presence of an anomaly, the method may include identifying, by the one or more processors and from the image, one or more properties of the anomaly including a size, location, orientation, persistence, shade, color, opacity, reflectivity, motion characteristics, temporal stability, pixel density distribution, heat signature, behavioral patterns and categorizing the anomaly based on the one or more properties.

The method may include obtaining training image data indicative of training images of the environment. At least one of the training images may include an anomaly in the environment. The method may further include annotating background regions and anomalies in the plurality of training images to generate annotated training images. The method may include training, using the plurality of annotated training images, the machine learning model to identify background regions and perform image segmentation of background regions in images. Training the machine learning may include training the machine learning model to identify background regions and perform image segmentation of background regions based on the background mask. The method may also include performing image augmentations on one or more of the training images to produce additional training images, and training the machine learning model to identify background regions and perform image segmentation of background regions using the additional training images. The training images may include one or more images obtained by the one or more image sensors.

Embodiments may be described in connection with a rail vehicle system, such as a locomotive or switcher, or other types of vehicle systems, such as automobiles, trucks (with or without trailers), buses, marine vessels, aircraft, unmanned aircraft (e.g., drones), mining vehicles, agricultural vehicles, or other off-highway vehicles. Vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers), or virtually or logically coupled but not mechanically coupled. For example, vehicles may be logically but not mechanically coupled when the separate vehicles communicate with each other to coordinate movements of the vehicles with each other so that the vehicles travel together (e.g., as a convoy, swarm, consist, platoon). Calculations and computations, such as navigation processes, may be performed on-board the vehicle systems or off-board the vehicle systems and then communicated to the vehicle systems. Whether on-board or off-board, a vehicle control system may operate a vehicle system and receive and process sensor inputs, operator inputs, operational parameters, vehicle parameters, and route parameters, etc.

The terms “control circuit” and “controller” are substitutable with each other and encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features may be stored in various types of memory. Suitable memory may include dynamic random-access memory (DRAM), flash memory, and/or cache. These instructions may be distributed over a network or via other computer-readable media. The term “non-transitory computer-readable medium” refers to any physical medium capable of storing or transmitting instructions or information that may be read by a machine. Examples of suitable media include RAM, ROM, EPROM, EEPROM, magnetic or optical media, flash memory, or even propagated signals such as carrier waves or infrared signals.

In some embodiments, the control circuit may utilize machine learning (ML) techniques to make decisions based on sensor inputs or other data. Suitable ML methods may include supervised learning (with labeled inputs and outputs), unsupervised learning (for identifying patterns), or reinforcement learning (where the system adapts based on feedback). Suitable tasks for ML systems may involve classification, regression, clustering, anomaly detection, or optimization. ML may employ algorithms, such as decision trees, deep learning, support vector machines (SVMs), or neural networks, depending on the application. A suitable control circuit may incorporate a policy engine that applies specific rules based on equipment characteristics or environmental conditions. For instance, a neural network could process sensor data or operational inputs to determine appropriate actions. Techniques such as backpropagation or evolutionary strategies may be used to refine neural network parameters and optimize model selection for the given task.

In one embodiment, the control circuit (or controller) and system described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

As mentioned above, the control circuit may include a policy engine. The policies the engine may apply may be based at least in part on characteristics of a given item of equipment or environment. For example, an artificial intelligence system, such as a neural network, may receive input of a number of environmental and task-related parameters. These parameters may include, for example, operational input of the given equipment, data from various sensors, environmental information, location and/or position data, and the like. The neural network may be trained and may generate an output based on these inputs, with the output representing an action or sequence of actions that the equipment or system should take to accomplish the goal of the operation. The control circuit may process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network may be generated and adjustments to the parameters may be made with subsequent simulations. Once the outputs from the various models have been obtained, they may be evaluated on their performance using a determined success metric. The best model or a good-enough model may be selected, and the control circuit may execute that plan to achieve the desired input data to mirror the predicted ‘best outcome’ scenario. Additionally, the success metric itself may be a combination of the optimized outcomes, which may be weighed relative to each other. Success metrics may be dynamically established, and the process rerun and the equipment directions further modified.

In one embodiment, data may be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

In one embodiment, vehicle systems may implement secure authentication processes, encryption protocols, and firewalls to protect against unauthorized access or spoofing. A suitable control circuit may include a security module responsible for detecting and responding to suspicious activities, such as unapproved data access attempts or irregular communication patterns. This module may employ machine learning to adapt its defense strategies, learning from previous attacks and adjusting security measures as needed to prevent similar breaches.

Vehicle systems in various embodiments may use a combination of local and remote sensors to monitor environmental conditions, vehicle status, and external inputs. These sensors may detect parameters such as speed, acceleration, braking status, location, proximity to other objects or vehicles, ambient temperature, humidity, and lighting conditions. raw data gathered by these sensors may feed into the control circuit, which in turn may respond to the input. The responses may include dynamically adjusting vehicle operations in response to real-time or near real-time changes in the environment or vehicle parameters; and, processing the data for further analysis. In certain embodiments, sensors may utilize various types of communication protocols (e.g., Bluetooth, ZigBee, Wi-Fi, or cellular networks) to share data with control systems both within the vehicle and to external data processing centers.

In certain embodiments, maintenance and diagnostic functions may be integrated into the control circuit, enabling the system to self-monitor for operational health. The control circuit may utilize diagnostic algorithms to assess the status of various vehicle components, such as engines, brakes, batteries, fuel cells and fuel systems, propulsion systems, and electronic systems (if present). If a component is found to be underperforming or at risk of failure, the control circuit may schedule alerts, recommend maintenance, or initiate safety protocols to avoid catastrophic failure. Self-diagnostics may use historical performance data to identify trends, facilitating proactive rather than reactive maintenance.

Terms such as “processing,” “computing,” “calculating,” or “determining” refer to operations carried out by the control circuit, which may include computing systems or electronic devices that manipulate data represented as physical (electronic) quantities within memory or registers. One or more components may be described as “configured to,” “configurable to,” “operable/operative to,” “adapted/adaptable to,” or similar terms. Unless explicitly stated, these terms encompass components in both active and inactive states. Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A system comprising:
one or more image sensors configured to generate sensor signals indicative of a field of view of the image sensors, the field of view including an environment with a doorway region, the doorway region including at least a portion of a floor in proximity to a door of a vehicle; and
a control circuit configured to:
obtain, via the one or more image sensors, image data indicative of an image of the environment;
identify, via a trained machine learning model, one or more background regions in the image;
identify a zone of interest in the image, the zone of interest including at least a portion of the doorway region;
determine an amount of overlap of the one or more background regions with the zone of interest; and
determine the presence of an anomaly in the image based on the amount of overlap of the one or more background regions with the zone of interest.

2. The system of claim 1, wherein the control circuit is further configured to control operation of the door based on the determination of the presence of the anomaly.

3. The system of claim 2, wherein to control operation of the door, the control circuit is configured to control one or more of (i) opening the door, (ii) closing the door, (iii) maintaining a current physical state of the door, (iv) a manual operation mode, or (v) an automatic operation mode.

4. The system of claim 1, wherein to identify the one or more background regions, the control circuit is further configured to segment, using a trained machine learning model, the image into a plurality of image segments and identify the one or more background regions from the image segments.

5. The system of claim 1, wherein the control circuit is further configured to:
generate a background mask from the one or more background regions, the background mask being a binary mask; and
wherein to determine the amount of overlap of the background regions with the zone of interest the control circuit is configured to determine an amount of overlap of the background mask with the zone of interest.

6. The system of claim 1, wherein the control circuit is further configured to:
compare the amount of overlap of the background regions and the zone of interest to an overlap threshold; and
wherein to determine the presence of the anomaly, the control circuit is configured to (i) identify that an anomaly is present if the amount of overlap is less than the overlap threshold or (ii) identify that an anomaly is not present if the amount of overlap is greater than the overlap threshold.

7. The system of claim 6, wherein the overlap threshold is a dynamic threshold that depends on at least one of environmental conditions, operational parameters, or historical performance data.

8. The system of claim 6, wherein, in response to identifying the presence of an anomaly, the control circuit is further configured to:
identify one or more properties of the anomaly including one or more of size, location, orientation, persistence, shade, color, opacity, reflectivity, motion characteristics, temporal stability, pixel density distribution, heat signature, or behavioral patterns; and
categorize the anomaly based on the one or more properties.

9. The system of claim 1, wherein the zone of interest comprises a plurality of sub-zones and wherein to determine the presence of an anomaly, the control circuit is configured to:
determine an amount of overlap of the background regions with each sub-zone; and
determine a presence of an anomaly in the image based on the amount of overlap of the background regions with each sub-zone of interest.

10. The system of claim 1, wherein the control circuit is further configured to generate a notification indicative of the determination of the presence of the anomaly.

11. A method comprising:
obtaining, via one or more image sensors, image data indicative of an image of an environment with a doorway region, the doorway region including at least a portion of a floor in proximity to a door;
identifying, via one or more control circuits and by a trained machine learning model, one or more background regions of the image;
identifying a zone of interest in the image, the zone of interest including at least a portion of the doorway region;
determining an amount of overlap of the one or more background regions with the zone of interest; and
determining the presence of an anomaly in the image based on the amount of overlap of the one or more background regions with the zone of interest.

12. The method of claim 11, further comprising controlling an operational state of the door based on the determination of the presence of the anomaly.

13. The method of claim 12, wherein controlling the operational state of the door includes controlling one or more of (i) a manual operation mode, (ii) an automatic operation made, (iii) opening the door, (iv) closing the door, or (v) maintaining a current physical state of the door.

14. The method of claim 11, wherein identifying the one or more background regions comprises performing, via the trained machine learning model, image segmentation and segmenting the image into the one or more background regions.

15. The method of claim 11, further comprising generating a background mask from the one or more background regions, the background mask being a binary mask, and wherein determining an amount of overlap of the background regions with the zone of interest comprises determining an amount of overlap of the background mask with the zone of interest.

16. The method of claim 11, wherein the method further comprises:
identifying, by the one or more control circuits and from the image, one or more properties of the anomaly including one or more of a size, location, orientation, persistence, shade, color, opacity, reflectivity, motion characteristics, temporal stability, pixel density distribution, heat signature, behavioral patterns; and
categorizing the anomaly based on the one or more properties.

17. The method of claim 11, further comprising:
obtaining training image data indicative of training images of the environment, with at least one of the training images including an anomaly in the environment;
annotating background regions and anomalies in training images to generate annotated training images; and
training, using annotated training images, the machine learning model to identify background regions and perform image segmentation of background regions in images.

18. The method of claim 17, further comprising generating a background mask from the annotated background regions, and wherein training the machine learning comprises training the machine learning model to identify background regions and perform image segmentation of background regions based on the background mask.

19. The method of claim 17, further comprising:
performing image augmentations on one or more of the training images to produce additional training images; and
training the machine learning model to identify background regions and perform image segmentation of background regions using the additional training images.

20. The method of claim 17, wherein the training images includes one or more images obtained by the one or more image sensors.
